(19) United States
(12) Patent Application Publication
(10) Pub. No.: US 2015/0213462 A1
(43) Pub. Date: Jul. 30, 2015

(54) HIGHLIGHTING BUSINESS TRENDS

(71) Applicant: Go Daddy Operating Company, LLC, Scottsdale, AZ (US)

(72) Inventor: Rajinder Nijjer, Phoenix, AZ (US)

(73) Assignee: Go Daddy Operating Company, LLC, Scottsdale, AZ (US)

(21) Appl. No.: 14/163,319

(22) Filed: Jan. 24, 2014

(51) Int. Cl. G06Q 30/02; G06F 17/27

(52) U.S. Cl. CPC G06Q 30/0201; G06F 17/2705

(57) ABSTRACT

Systems and methods are disclosed for determining business trends. Data may be collected and stored in a database regarding domain name registrations, availability checks and/or search engine user queries. In preferred embodiments, the data includes temporal or order information regarding when the data was collected. The data may be parsed into a plurality of tokens, where each token is a word or group of words commonly used together. How often each token appears in the data, over time, may be calculated. In some embodiments, related tokens (such as synonyms, abbreviations, common misspellings, geographically related, categories, etc.) may be grouped and considered together. One or more business trends may be determined based on how often, or changes to how often over time, the tokens appear in the data. The changes of token usage and/or business trends may be transmitted over a computer network to a client computer.

### FIELD OF THE INVENTION

The present invention generally relates to the field of determining business trends and, as a specific example, examining the frequency tokens are used in domain names and/or search engine over time to determine business trends.

### SUMMARY OF THE INVENTION

The present invention provides systems and methods for determining business trends through the analysis of domain names registrations, availability checks of domain names, domain names entered into browsers and/or search engine user queries. By continuously or periodically sampling one or more of these data types, business trends may be followed over any desired length of time. This information may be used by merchants and entrepreneurs to determine which products and/or services have potential (or should be avoided) in the current business environment.

The system may comprise a database storing data, wherein the data includes domain name registrations, availability checks of domain names, domain names entered into browsers and/or search engine user queries. While the data may be periodically sampled at different times, in preferred embodiments, the data is continuously logged and includes temporal information. The database may be operated from one or more hardware severs.

The system may also comprise a software application, running on the one or more hardware servers, configured to parse the data into a plurality of tokens, calculate how frequently one or more of the tokens appear in the data, and determine one or more business trends based on how frequently the one or more tokens appear in the data. In preferred embodiments, the data, coming from different times, is compared to each other to determine changes or trends in the token usage.

A method may include the step of parsing data in a database into a plurality of token. Words that are prepositions, pronouns, articles, have been found to be unhelpful in past, and/or not related to business trends that are currently being analyzed may be dropped from consideration. The data may be from two or more different time periods, but is preferably a continuous log of stored data that includes temporal information. Further, tokens may be limited to only those related to certain areas, topics, and/or geographic regions of interest. How often each token appears in the data may be calculated. One or more business trends may be determined based on how often the one or more tokens appear in the data and, preferably, how token usage changes over time. The results of the one or more business trends may be transmitted to a client computer over a computer network.

In an alternate method, related (synonyms, common misspellings, added suffixes or prefixes, plurals, abbreviations, commonly associated, etc.) tokens are grouped together. As one option, tokens related to a specific business may be combined together. This may be repeated for additional types of businesses, thereby creating a plurality of groups, each for a different business. As another option, tokens related to a specific geographical area may be combined together. This may be repeated for additional geographical regions, thereby creating a plurality of groups, each for a different geographical region. Customized groupings in this manner may be used to monitor business activities of different business and/or geographical regions.

The above features and advantages of the present invention will be better understood from the following detailed description taken in conjunction with the accompanying drawings.

### BRIEF DESCRIPTION OF THE DRAWINGS

FIG. 1 is a block diagram of a system that may be used to practice the present invention.

FIG. 2 illustrates a storage medium for storing data that may be used to practice the invention.

FIG. 3 illustrates a first data set over a first period of time that may be used to practice the invention.

FIG. 4 illustrates a first table that shows tokens in the first data set and how often the tokens were in the first data set.

FIG. 5 illustrates a second data set over a second period of time that may be used to practice the invention.

FIG. 6 illustrates a second table that shows tokens in the second data set and how often the tokens were in the second data set.

FIG. 7 illustrates a table that shows how often the tokens appeared in the first data set, how often the tokens appeared in the second data set, and the delta or trend for token usage over time.

FIG. 8 illustrates a flow diagram for practicing an embodiment of the invention.

FIG. 9 illustrates a flow diagram for practicing another embodiment of the invention.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

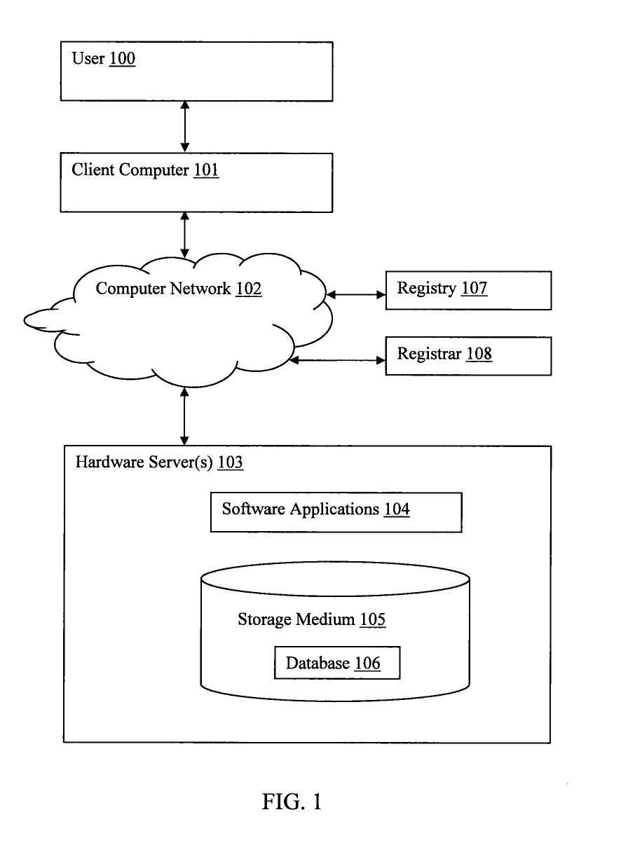

FIG. 1 is a block diagram of a system that may be used to practice the present invention. A computer network 102 is a collection of links and nodes (e.g., multiple computers and/or other devices connected together) arranged so that information may be passed from one part of the computer network 102 to another over multiple links and through various nodes. Examples of computer networks 102 include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users 100 on client computers 101. Hundreds of millions of people around the world have access to client computers 101 connected to the Internet via Internet Service Providers (ISPs). Content providers place multimedia information (e.g., text, graphics, audio, video, animation, and other forms of data) at specific locations on the Internet referred to as websites. The combination of all the websites and their corresponding web pages on the Internet is generally known as the World Wide Web (WWW) or simply the Web.

For Internet users 100 and businesses alike, the Internet continues to be increasingly valuable. More people use the Web for everyday tasks, from social networking, shopping, banking, and paying bills to consuming media and entertainment. E-commerce is growing, with businesses delivering more services and content across the Internet, communicating and collaborating online, and inventing new ways to connect with each other.

Prevalent on the Web are multimedia websites, some of which may offer and sell goods and services to individuals and organizations. Websites may consist of a single webpage, but typically consist of multiple interconnected and related webpages. Websites, unless very large and complex or have unusual traffic demands, typically reside on a single server and are prepared and maintained by a single individual or entity (although websites residing on multiple servers are certainly possible). Menus, links, tabs, etc. may be used to move between different web pages within the website or to move to a different website.

Websites may be created using HyperText Markup Language (HTML) to generate a standard set of tags that define how the webpages for the website are to be displayed. Users 100 of the Internet may access content providers' websites using software known as an Internet browser, such as MICROSOFT INTERNET EXPLORER or MOZILLA FIREFOX. The user 100 may enter a domain name into the browser to move from one website to another website. After the browser has located the desired webpage 105, it requests and receives information from the webpage, typically in the form of an HTML document, and then displays the webpage content for the user 100 on the client computer 101. The user 100 then may view other webpages at the same website or move to an entirely different website by entering a different domain name in the browser.

Some website operators, typically those that are larger and more sophisticated, may provide their own hardware, software, and connections to the Internet. However, most website operators either do not have the resources available or do not want to create and maintain the infrastructure necessary to host their own websites. To assist such individuals (or entities), hosting companies exist that offer website hosting services. These hosting providers typically provide the hardware, software, and electronic communication means necessary to connect multiple websites to the Internet. A single hosting provider may literally host thousands of websites on one or more hosting servers.

Browsers are able to locate specific websites because each website, resource, and computer on the Internet has a unique Internet Protocol (IP) address. Presently, there are two standards for IP addresses. The older IP address standard, often called IP Version 4 (IPv4), is a 32-bit binary number, which is typically shown in dotted decimal notation, where four 8-bit bytes are separated by a dot from each other (e.g., 64.202.167.32). The notation is used to improve human readability. The newer IP address standard, often called IP Version 6 (IPv6) or Next Generation Internet Protocol (IPng), is a 128-bit binary number. The standard human readable notation for IPv6 addresses presents the address as eight 16-bit hexadecimal words, each separated by a colon (e.g., 2EDC:BA98:0332:0000:CF8A:000C:2154:7313).

IP addresses, however, even in human readable notation, are difficult for people to remember and use. A Uniform Resource Locator (URL) is much easier to remember and may be used to point to any computer, directory, or file on the Internet. A browser is able to access a website on the Internet through the use of a URL. The URL may include a Hypertext Transfer Protocol (HTTP) request combined with the website's Internet address, also known as the website's domain name. An example of a URL with a HTTP request and domain name is: http://www.companyname.com. In this example, the “http” identifies the URL as a HTTP request and the “companyname.com” is the domain name.

Domain names are much easier to remember and use than their corresponding IP addresses. The Internet Corporation for Assigned Names and Numbers (ICANN) approves some Generic Top-Level Domains (gTLD) and delegates the responsibility to a particular organization (a “registry”) for maintaining an authoritative source for the registered domain names within a TLD and their corresponding IP addresses. For certain TLDs (e.g., .biz, .info, .name, and .org) the Registry 107 is also the authoritative source for contact information related to the domain name and is referred to as a “thick” Registry 107. For other TLDs (e.g., .com and .net) only the domain name, registrar identification, and name server information is stored within the Registry 107, and a Registrar 108 is the authoritative source for the contact information related to the domain name. Such Registries 107 are referred to as “thin” registries 107. Most gTLDs are organized through a central domain name Shared Registration System (SRS) based on their TLD.

The process for registering a domain name with .com, .net, .org, and some other TLDs allows an Internet user 100 to use an ICANN-accredited Registrar 108 to register their domain name. For example, if an Internet user 100, John Doe, wishes to register the domain name “mycompany.com,” John Doe may initially determine whether the desired domain name is available by contacting a domain name Registrar 108. The Internet user 100 may make this contact using the Registrar's webpage and typing the desired domain name into a field on the registrar's webpage created for this purpose. Upon receiving the request from the Internet user 100, the Registrar may ascertain whether “mycompany.com” has already been registered by checking the SRS database associated with the TLD of the domain name, checking zone files of registered domain names or by checking with the Registry. The results of the search may be displayed on the webpage to thereby notify the Internet user 100 of the availability of the domain name. If the domain name is available, the Internet user 100 may proceed with the registration process. If the domain name is not available for registration, the Internet user 100 may keep selecting alternative domain names until a desired and available domain name is found.

The invention may include one or more hardware server(s) 103. The hardware server(s) 103 include at least one hardware server, which may be, as a non-limiting example, one or more Dell PowerEdge(s) rack server(s). The hardware server(s) 103 may use software applications 104 and be connected to routers and other equipment necessary to communicate via the computer network 102. The hardware server(s) may provide the infrastructure and a platform for software applications 104 and storage medium 105 to operate.

The storage medium 105, run on the server(s) 103, may be used to practice the invention. The storage medium 105 may store one or more databases 106 and/or files. A database is an organized collection of data. The data are typically organized to model relevant aspects of reality in a way that supports processes requiring this information. Database management systems (DBMSs) are specially designed applications to store, save, and organize the data in the databases 106. A general-purpose database management system (DBMS) is a software system designed to allow the definition, creation, querying, update, and administration of databases. As non-limiting examples, DBMSs may include MySQL, MariaDB, PostgreSQL, SQLite, Microsoft SQL Server, Oracle, SAP, dBASE, FoxPro, IBM DB2, LibreOffice Base and FileMaker Pro.

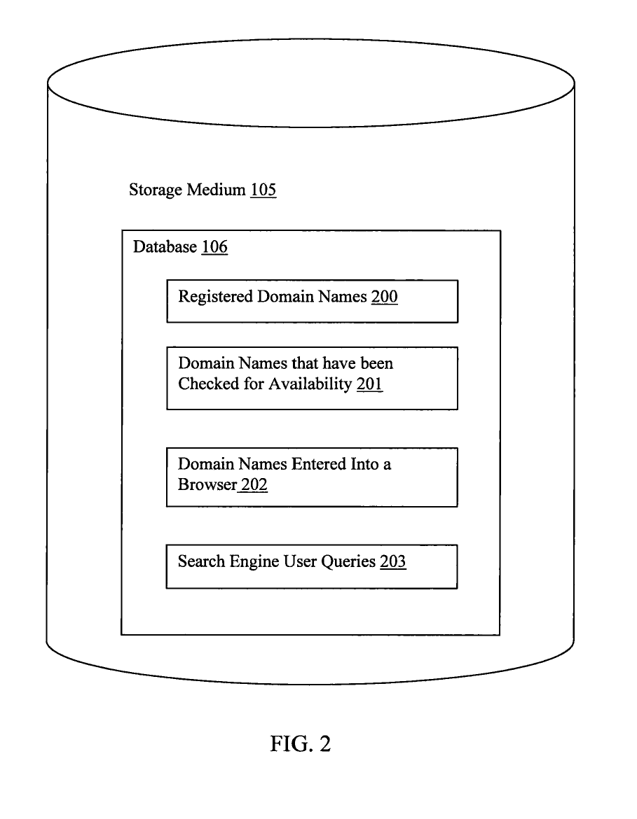

Any type of storage medium 105 on the hardware server(s) 103 may be used to practice the current invention such as, as non-limiting examples, hard disk drives, RAM, tapes, and/or flash drives. FIG. 2 illustrates a database 106 stored on a storage medium 105. The database 106 may store information on registered domain names 200, domain names that have been checked for availability 201, domain names entered into browsers 202, and/or search engine user queries 203. In preferred embodiments, the data in the database 106 includes temporal and/or order information for the domain names and user queries so that changes over time may be determined from the data.

Data on registered domain names 200 may be collected by, as non-limiting examples, domain name registrars 108 (such as Go Daddy) and/or domain name registries 107. Data on domain names that have been checked for availability 201 may also be collected by domain name registrars 108 (such as Go Daddy) and/or domain name registries 107. Data on domain names entered into browsers 202 may be collected by browsers (such as Microsoft 1E, Google Chrome, and Mozilla Firefox). Data on search engine user queries 203 may be collected by search engines (such as Microsoft Bing, Google Search and Yahoo!). The invention may be practiced using domain name and search engine user query data from any source, i.e., the invention is not limited to any particular source of data.

In a preferred embodiment, the data in the database 106 may be analyzed over time. Thus, in preferred embodiments, the data has some mechanism, such as time stamping or positioning, to indicate a temporal relationship of the data.

Software applications 104, comprising one or more computer software applications, programs, code, modules, subroutines, etc. (hereafter software applications 104) may access the data in the database 106 and operate on the hardware server(s) 103. The software applications 104 may parse out tokens from domain names and search engine user queries, quantify how often each token is used, group related tokens, and analyze trends (such as business trends) in the token's usage over time.

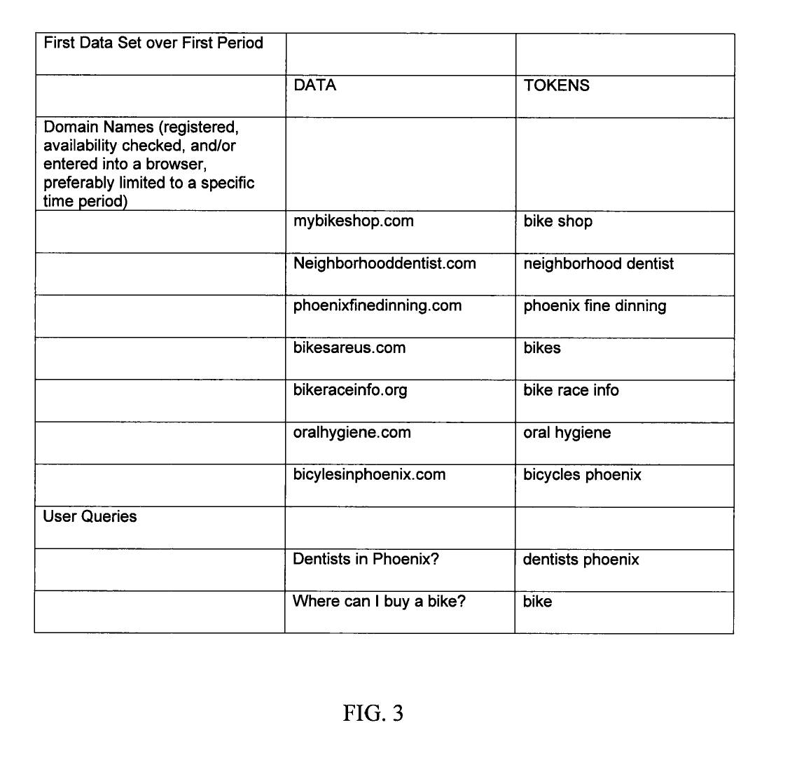

FIG. 3 illustrates some example data of domain names and user queries. The domain names may be registered domain names, domain names that have been checked for availability, and/or domain names entered into one or more browsers. User queries may be queries users have entered into a search engine. Each domain name and/or user query may be parsed into zero or more tokens. The domain names and user queries may be parsed into tokens by comparing character strings in the domain names and/or user queries with words from, as a non-limiting example, an electronic dictionary. Matches between the character strings and the electronic dictionary may be used to indicate that a character string is a token. Prepositions, pronouns, articles, stop words, etc. are preferably removed from consideration and not turned into tokens.

As an example, the first shown domain name “mybikeshop.com” in FIG. 3 may be parsed into the tokens “bike” and “shop.” The string “my” may be excluded from consideration as it is unlikely to help determine any trends in the data. Smart algorithms may also be used to insure the most likely intended tokens are determined. As an example, “mybikeshop.com” could be broken down into tokens “bikes” and “hop” or into tokens “bike” and “shop.” A smart algorithm, possibly using data from various word usage databases, may be used to determine the more likely intended usage, which is “bike” and “shop.”

Optionally, some embodiments may also tokenize the domain name extensions and track domain name extensions' usage. As another option, words commonly used together may be kept together as a single token. For example, “oral hygiene” may be kept together when the two words are found next to each other. The remaining domain names and user queries (in the DATA column) may also be parsed into tokens (as shown in the TOKENS column) as further illustrated in FIG. 3.

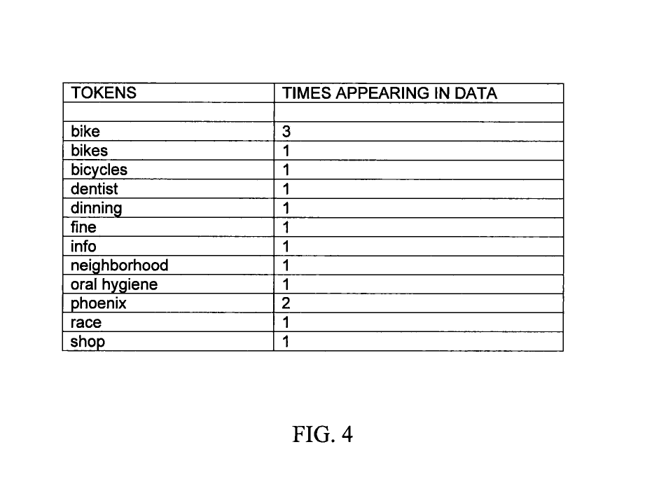

After the data has been tokenized, the tokens may be analyzed by any method, now known or developed in the future, to determine trends in the data. One such non-limiting method is illustrated in FIG. 4 where the number of times each token appears in a first set of data (from FIG. 3) is determined. The number may be determined by simply counting the number of occurrences of each token in the data.

Optionally, groups of tokens may be created so that, as non-limiting examples, different businesses or geographical regions may be compared. As another option, groups of tokens that are synonyms, abbreviations, closely related and/or common misspellings of each other may also be grouped together. As an example, in FIG. 4, “bike,” “bikes,” and “bicycles” may be grouped together and treated as a single group.

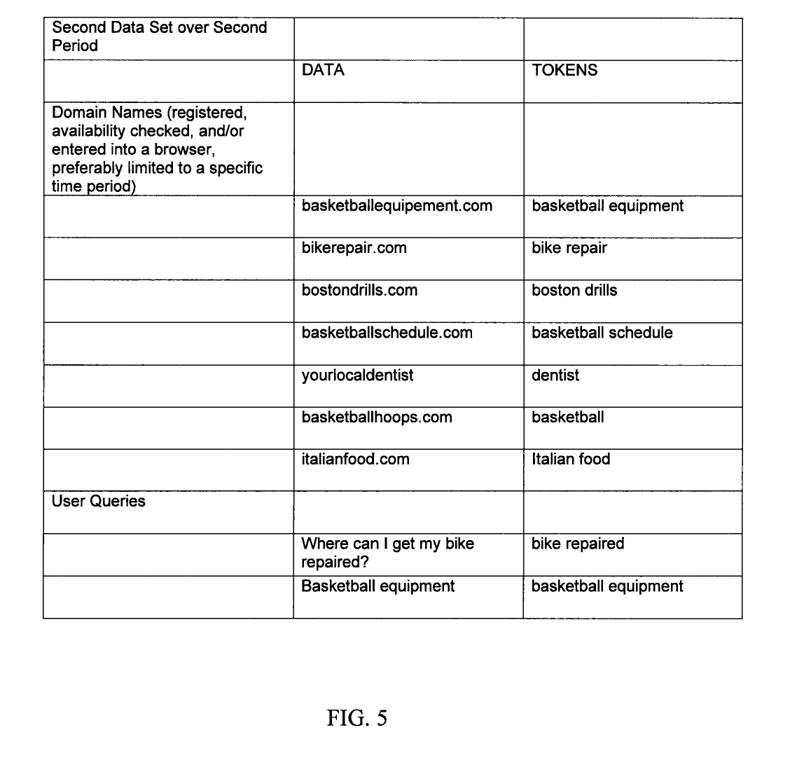

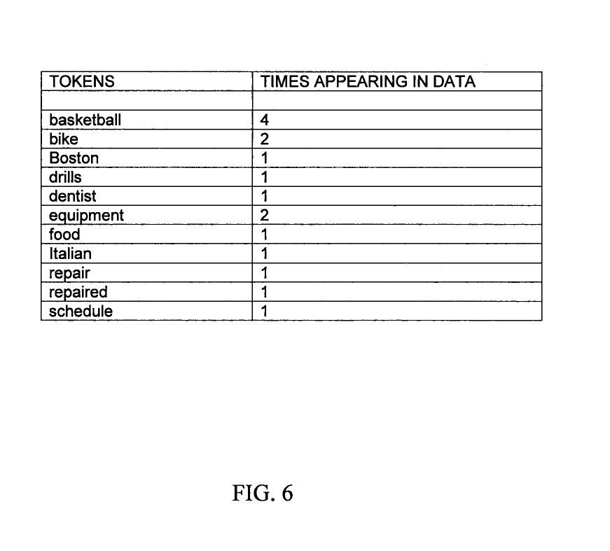

FIG. 5 illustrates a second set of data over a second period of time, with the domain names and user queries broken down into tokens. FIG. 6 illustrates how often each token appears in the second set of data.

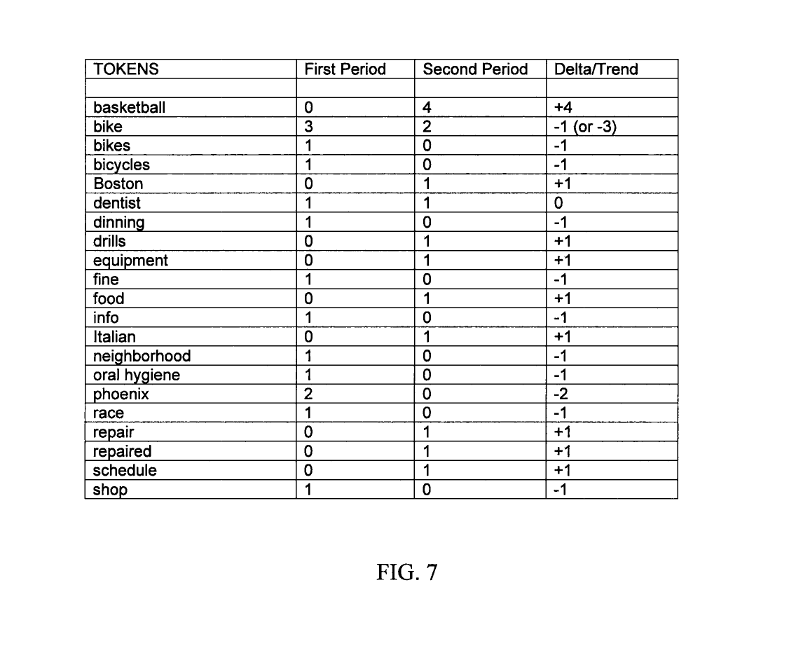

FIG. 7 compares the token use in the first set of data with the token use in the second set of data. Trends are difficult to determine based on a single sample (set of data), thus in preferred embodiments, data for domain names and user queries are either continuously collected or sampled at a plurality of different times. While FIG. 3 illustrates an example first data set over a first period of time and FIG. 5 illustrates an example second data set over a second period of time, in practice many more data sets may be used that include much more data. This will allow business trends to be tracked over a much longer period of time with greater resolution. In preferred embodiments, continuous data logs of domain names and user queries may be analyzed and broken down into different time periods to allow business trends to be analyzed over any desired time period using any desired sampling resolution.

Business trends may be determined based on the number of times the various tokens appear in the data with the assumption that the more often a token appears in the data, the hotter or more active businesses are that are related to that token. As an example, “bike” (3 times), “bikes” (1 time) and “bicycles” (1 time) appear 5 times in total in the first sample, but only “bike” (2 times) appears in the second data set. This may indicate that businesses related to bikes are slowing down during this time period. On the other hand, “basketball” did not show up at all in the first time period, but appeared 4 times in the second time period. This may indicate that businesses related to basketball may be enjoying an uptick in activity. As another example, tokens related the same geographical areas may be combined (such as city names for a state) into the same group. This allows geographical areas to be compared over time for business trends.

These very basic examples are intended for illustration purposes only and other more sophisticated methods of normalizing the data and performing statistical and relational analysis may be used to find and determine various business trends.

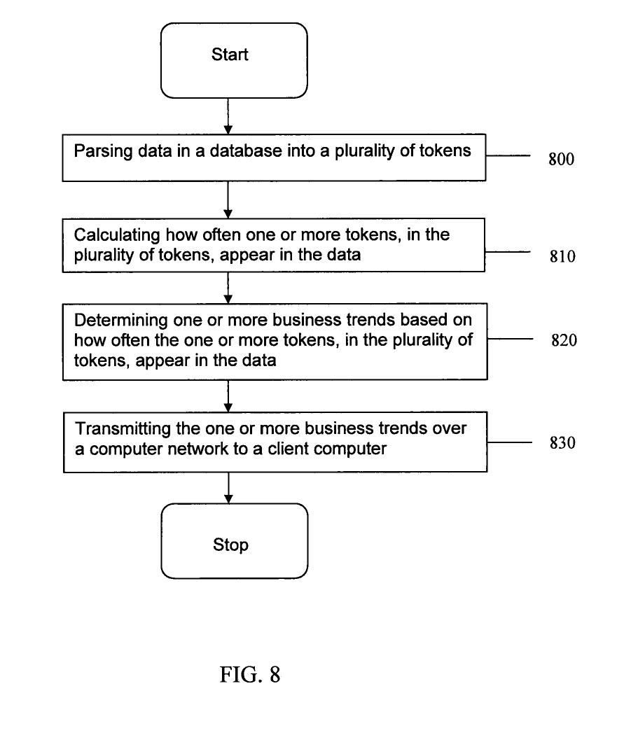

FIG. 8 illustrates an example method for practicing the invention. Data in a database 106, having domain names and/or search engine user queries, may be parsed into tokens by a software application 104. (Step 800) The database 106 may be stored on a storage medium 105 running on a hardware server 103. In a preferred embodiment, a temporal aspect of the data is kept with the tokens. For example, the time when a domain name, having the token, was registered, checked for availability or entered into a browser or the time when a user query, having the token, was entered into a search engine. In another embodiment, the order of occurrence of the described events is tracked.

The software application 104 may calculate how frequently, i.e. how often, each token appears in the data. (Step 810) Preferably, the data is either grouped into a plurality of different time periods or analyzed over time. This allows changes in the data, i.e. token usage, over time to be used to determine trends. Based on the changes of token use over time, one or more business trends may be determined. (Step 820) The business trends may be transmitted to the client computer 101 through the use of a website, API, or any other method now known, or developed in the future, of transmitting data over a computer network 102. (Step 830)

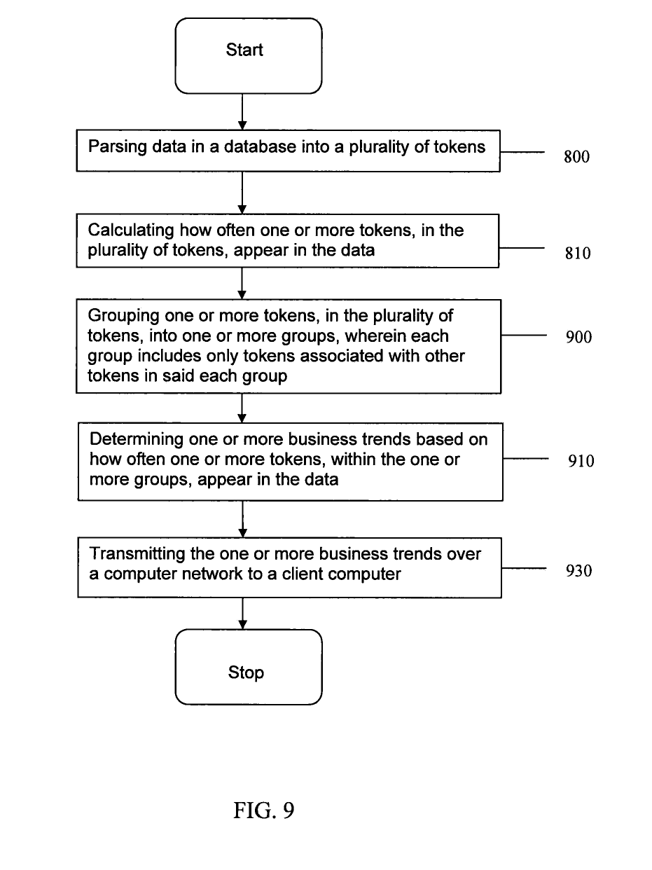

FIG. 9 illustrate another method for practicing the invention. As in the previous method illustrated in FIG. 8, the data in a database 106 may be parsed into tokens (Step 800) and the number of occurrences of each token is determined (Step 810). In this embodiment, tokens are grouped together that are related. (Step 900) For example, tokens related to specific geographic areas may be grouped together to determine business trends for that geographic area over time. Other tokens may be grouped together for other geographical areas allowing the areas to be compared over time. The flexibility in grouping tokens as desired is a very powerful tool in determining business trends across different categories of businesses and/or across different geographical regions. (Step 910) The discovered business trends may be transmitted to the client computer 101 through the use of a website, API, or any other method now known, or developed in the future, of transmitting data over a computer network 102. (Step 930)

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

The invention claimed is:

1. A system, comprising:
a) a database comprising data, wherein the database is stored on a storage medium running on one or more hardware servers; and
b) a software application, running on the one or more hardware servers, configured to parse the data into a plurality of tokens, determine how often one or more tokens, in the plurality of tokens, appear in the data, and resolve one or more business trends based on how often the one or more tokens, in the plurality of tokens, appear in the data.

2. The system of claim 1, wherein the data comprises a plurality of domain names registered over a predetermined period of time.

3. The system of claim 1, wherein the data comprises a first plurality of domain names registered over a first predetermined period of time and a second plurality of domain names registered over a second predetermined period of time.

4. The system of claim 1, wherein the data comprises a plurality of domain names that have been checked for availability.

5. The system of claim 1, wherein the data comprises a plurality of domain names entered into one or more browsers.

6. The system of claim 1, wherein the data comprises a plurality of search engine user queries.

7. A method, comprising the steps of:
a) parsing data in a database into a plurality of tokens, wherein the database is stored on a storage medium run on one or more hardware servers;
b) calculating how often one or more tokens, in the plurality of tokens, appear in the data;
c) determining one or more business trends based on how often the one or more tokens, in the plurality of tokens, appear in the data; and
d) transmitting the one or more business trends over a computer network to a client computer.

8. The method of claim 7, wherein the data comprises a plurality of domain names registered over a period of time.

9. The method of claim 7, wherein the data comprises a first plurality of domain names registered over a first predetermined period of time and a second plurality of domain names registered over a second predetermined period of time.

10. The method of claim 9, wherein the determining one or more business trends is also based on how often the one or more tokens, in the plurality of tokens, appear in the first plurality of domain names compared to how often the one or more tokens, in the plurality of tokens, appear in the second plurality of domain names.

11. The method of claim 7, wherein the data comprises a plurality of domain names entered into one or more browsers or a plurality of domain names that have been checked for availability.

12. The method of claim 7, wherein the data comprises a plurality of search engine user queries.

13. A method, comprising the steps of:
a) parsing data in a database into a plurality of tokens, wherein the database is stored on a storage medium run on one or more hardware servers;
b) calculating how frequently one or more tokens, in the plurality of tokens, appear in the data;
c) grouping one or more tokens, in the plurality of tokens, into one or more groups, wherein each group includes only tokens associated with other tokens in the group;
d) determining one or more business trends based on how often one or more tokens, within the one or more groups, appear in the data; and
e) transmitting the one or more business trends over a computer network to a client computer.

14. The method of claim 13, wherein the data comprises a plurality of domain names registered over a period of time.

15. The method of claim 13, wherein the data comprises a first plurality of domain names registered over a first predetermined period of time and a second plurality of domain names registered over a second predetermined period of time.

16. The method of claim 15, wherein the determining one or more business trends is also based on how often the one or more tokens, in the plurality of tokens, appear in the first plurality of domain names compared to how often the one or more tokens, in the plurality of tokens, appear in the second plurality of domain names.

17. The method of claim 13, wherein the data comprises a plurality of domain names entered into one or more browsers and/or a plurality of domain names the have been checked for availability.

18. The method of claim 13, wherein the data comprises a plurality of search engine user queries.

19. The method of claim 13, wherein one or more groups are related to a type of business.

20. The method of claim 13, wherein one or more groups are related to a geographic area.
